(19) United States
(12) Patent Application Publication
(10) Pub. No.: US 2018/0275537 A1
(43) Pub. Date: Sep. 27, 2018

(54) PHOTORECEPTOR FOR ELECTROPHOTOGRAPHY AND ELECTROPHOTOGRAPHY DEVICE HAVING THE SAME

(71) Applicant: FUJI ELECTRIC CO., LTD., Kawasaki-shi (JP)

(72) Inventors: Tomoki HASEGAWA, Tokyo (JP); Shinjiro SUZUKI, Matsumoto-city (JP); Fengqiang ZHU, Matsumoto-city (JP); Hirotaka KOBAYASHI, Matsumoto-city (JP)

(73) Assignee: FUJI ELECTRIC CO., LTD., Kawasaki-shi (JP)

(21) Appl. No.: 15/994,597

(22) Filed: May 31, 2018

Related U.S. Application Data
(63) Continuation of application No. PCT/JP2017/014684, filed on Apr. 10, 2017.

(30) Foreign Application Priority Data
Jun. 30, 2016 (JP) 2016-130870

(51) Int. Cl. G03G 5/05; G03G 5/047; G03G 5/10; G03G 5/06

(52) U.S. Cl. CPC G03G 5/0507; G03G 5/047; G03G 5/0564; G03G 2215/00957; G03G 5/0696; G03G 5/0525; G03G 5/0546; G03G 5/102

(57) ABSTRACT

A photoreceptor for electrophotography and an electrophotography device having the same reduces wear loss of the photoreceptor surface and stably obtaining a favorable image for long time. The photoreceptor for electrophotography includes a conductive substrate and a charge transport layer provided on the conductive substrate. The charge transport layer contains a charge transport material, a resin binder, and an inorganic oxide filler surface-treated with a silane coupling agent. A difference (ΔSPa) in a dipole-dipole force component that is a Hansen solubility parameter between the charge transport material and the silane coupling agent satisfies a relationship ΔSPa<1.0. A difference (ΔSPb) in a London dispersion force component that is a Hansen solubility parameter between the resin binder and the silane coupling agent satisfies a relationship ΔSPb<2.5.

### CROSS-REFERENCE TO RELATED APPLICATIONS

This non-provisional application is a continuation of International Application No. PCT/JP2017/014684 filed on Apr. 10, 2017, which claims priority from Japanese Patent Application No. 2016-130870 filed on Jun. 30, 2016, the entire contents of both of which are incorporated herein by reference.

### BACKGROUND OF THE INVENTION

### 1. Field of the Invention

The present invention relates to the improvement of a photoreceptor for electrophotography (hereinafter also simply referred to as “photoreceptor”) and an electrophotography device having the same, which are used for electrophotographic printers, copying machines, fax machines, and the like.

### 2. Background of the Related Art

A photoreceptor for electrophotography has a basic structure in which a photosensitive layer having a photoconductive function is disposed on a conductive substrate.

In recent years, regarding organic photoreceptors for electrophotography containing an organic compound as a functional component responsible for charge generation and charge transport, research and development have been actively conducted by virtue of their advantages such as diversity of materials, high productivity, and safety. Thus, the application of the organic photoreceptors to copying machines, printers, and the like is underway.

In general, a photoreceptor must have a function to retain surface charges in the dark, a function to generate charges upon reception of light, and further, a function to transport generated charges. Existing photoreceptors are a so-called single layer type photoreceptor comprising a single layer photosensitive layer having a combination of these functions and a so-called laminated type (separate function type) photoreceptor comprising a photosensitive layer which is functionally separated into a charge generation layer that mainly functions to generate charges upon reception of light and a charge transport layer that functions to retain surface charges in the dark and transport charges generated by the charge generation layer upon reception of light, which are laminated together.

The above-described photosensitive layer is usually formed by applying a coating liquid, in which a charge generation material, a charge transport material, and a resin binder are dissolved or dispersed in an organic solvent, to a conductive substrate. In particular, for the layer to be the outermost surface of the organic photoreceptor, it is often seen that polycarbonate, which is resistant to friction occurring between the organic photoreceptor and a paper or blade for toner removal and has excellent flexibility and favorable permeability upon light exposure, is used as a resin binder. Bisphenol Z type polycarbonate is widely used as such a resin binder. A technique using this polycarbonate as a resin binder is described in, for example, Patent Document 1 (Japanese Unexamined Patent Application Publication No. S61-62040).

Meanwhile, in recent years, the mainstream electrophotography device is a so-called digital device for digitalizing images or textual information and converting the information into optical signals using monochromatic light emitted from an exposure light source such as argon, helium-neon, a semiconductor laser, or light emitting diode, irradiating a charged photoreceptor with light to form an electrostatic latent image on the surface of the photoreceptor, and visualizing the image with toner.

As a method for charging a photoreceptor, there are a noncontact charging method in which a charging member such as a scorotron and a photoreceptor are not brought into contact with each other and a contact charging method in which a charging member made of a semiconductive rubber roller or brush and a photoreceptor are brought into contact with each other. Of these, a noncontact charging method is characterized in that ozone is less likely to be generated due to the occurrence of corona discharge in the very vicinity of a photoreceptor and thus applied voltage may be set to a lower level, compared with a contact charging method. Accordingly, since a more compact and lower cost electrophotography device which is less environmentally polluting can be realized, the method has become the mainstream especially for middle- to small-sized devices.

As a means for cleaning the photoreceptor surface, a cleaning process involving scraping by a blade, simultaneous developing, or the like is mainly used. In the cleaning process using a blade, the untransferred residual toner on the photoreceptor surface is scraped off by a blade and then optionally collected in a waste toner collection box or returned into a developing device. Thus, in a case in which a cleaner for such method of scraping by a blade is used, there must be a toner collection box or a space for toner recycling, and it is required to monitor whether or not the collection box is full. Further, when paper dust or an external additive remains on the blade, there may be a case in which the photoreceptor surface is damaged, which results in shortened life of the photoreceptor. Therefore, in some cases, the toner is collected in the developing process or a process of magnetically or electrically sucking the residual toner adhered to the photoreceptor surface is introduced immediately before the developing process.

In addition, when using a cleaning blade, it is necessary to increase hardness and contact pressure of the blade in order to improve cleaning performance. In this regard, there may be a case in which abrasion of the photoreceptor surface is promoted, and it causes a potential fluctuation or sensitivity change, which results in an image abnormality, and thus, troubles occur in color balance and reproducibility in a color electrophotography device.

In order to solve these problems, a variety of methods of improving the outermost layer of a photoreceptor have been proposed. For example, Patent Document 2 (Japanese Unexamined Patent Application Publication No. H1-205171) and Patent Document 3 (Japanese Unexamined Patent Application Publication No. H7-333881) propose methods of adding a filler to the surface layer of a photoreceptor in order to improve durability of the photoreceptor surface. However, in a method of dispersing a filler in a layer, it is difficult to uniformly disperse the filler. Further, the presence of an aggregate of the filler, decreased permeability of the layer, or scattering of exposure light via a filler might cause nonuniform charge transport or charge generation, resulting in deterioration of image characteristics. Furthermore, although there is a method of adding a dispersing agent to improve the dispersibility of the filler, in this case, the dispersing agent itself affects photoreceptor characteristics, and, therefore, it is difficult to achieve satisfactory filler dispersibility and photoreceptor characteristics in a well-balanced manner.

In order to solve this issue, for example, Patent Document 4 (Japanese Unexamined Patent Application Publication No. H8-305051) and Patent Document 5 (Japanese Unexamined Patent Application Publication No. 2006-201744) propose techniques for improving the contents and dispersion state of a filler. However, the effects of these techniques are not sufficient, and therefore, the development of a photoreceptor for electrophotography that can achieve printing durability, repetition stability, and high resolution has been awaited.

In addition, Patent Document 6 (Japanese Unexamined Patent Application Publication No. 2006-301247) discloses an organic photoreceptor which contains inorganic particles having a number average primary particle diameter (Dp) of 5 to 100 nm which are surface-treated for a plurality of times and then subjected to surface treatment with a silazane compound as the final surface treatment. Patent Document 7 (Japanese Unexamined Patent Application Publication No. 2015-175948) discloses an electrophotographic photoreceptor having a photosensitive layer on the outermost surface, in which silica particles are contained in a predetermined amount together with a predetermined functional material.

As described above, various studies have been made on the improvement of the surface layer of a photoreceptor. In the technology disclosed in the above Patent Documents, the relationship among the respective components of the surface layer is not sufficiently examined, and it has been impossible to stably and favorably ensure electrical properties and image characteristics while sufficiently reducing the wear loss of the photoreceptor surface.

In view of the above, it is an object of the present invention to provide a photoreceptor for electrophotography and an electrophotography device having the same, by which the wear loss of the photoreceptor surface can be reduced, and a favorable image can be stably obtained for long time by solving the above-described problems.

### SUMMARY OF THE INVENTION

As a result of intensive studies in order to achieve the above-described object, the present inventors found that a photoreceptor for electrophotography, which has high durability due to a filler uniformly dispersed in layers thereof, can be obtained by adding a combination of a charge transport material, a resin binder, and a silane coupling surface treatment filler, which are highly compatible, to a layer to serve as a photoreceptor surface. This has led to the completion of the present invention.

Specifically, in a first aspect of the present invention, a photoreceptor for electrophotography comprising a conductive substrate and a charge transport layer provided on the conductive substrate, wherein the charge transport layer contains a charge transport material, a resin binder, and an inorganic oxide filler surface-treated with a silane coupling agent, a difference ΔSPa in a dipole-dipole force component that is a Hansen solubility parameter between the charge transport material and the silane coupling agent satisfies a relationship of ΔSPa<1.0, and a difference ΔSPb in a London dispersion force component that is a Hansen solubility parameter between the resin binder and the silane coupling agent satisfies a relationship of ΔSPb<2.5.

Here, the Hansen solubility parameters are calculated using the Hansen's formula, by which the interaction of intermolecular forces can be divided into a London dispersion force component, a dipole-dipole force component, and a hydrogen bonding force component. In the formula, a dipole-dipole force component that is a Hansen solubility parameter is calculated by the following formula:

δp=√ΣFp²/V (J^{1/2}/cm^{3/2}),

where Fp denotes cohesive energy of a Krevelen and Hoftyzer parameter related to each component's dipole, and V denotes the molar volume of each component.

In addition, the London dispersion force component δd that is a Hansen solubility parameter is calculated by the following formula:

δd=ΣFd/V (J^{1/2}/cm^{3/2}),

where Fd denotes cohesive energy of a Krevelen and Hoftyzer parameter related to each component's London dispersion force, and V denotes the molar volume of each component.

It is noted that, according to the present invention, in order to reduce the gap between two different materials regarding each of the above-described solubility parameters, the dipole-dipole force component and the London dispersion force component, which are Hansen solubility parameters, are expressed as SPa and SPb, respectively.

It is noted that regarding the above-described formulae, databases of values corresponding to cohesive energy densities and molar volume values for the individual components are available for each atomic group (Krevelen and Hoftyzer parameters) and introduced in literature.

The present inventors examined a correlation between each of the Hansen solubility parameters and compatibility between a charge transport material and a silane coupling agent and a correlation between each of the Hansen solubility parameters and compatibility between a resin binder and a silane coupling agent. As a result, it was found that there is a high correlation between the difference in the dipole-dipole force component and the compatibility in the former case and between the difference in the London dispersion force component and the compatibility in the latter case. Here, it has been confirmed that compatibility between a charge transport material and a resin binder is favorable within the scope of materials usually used in the field of photoreceptors. Therefore, compatibility between a charge transport material and a silane coupling agent and compatibility between a resin binder and a silane coupling agent have been examined according to the present invention. According to the study made by the present inventors, favorable print durability can be obtained by applying a composition, in which a difference ΔSPa in a dipole-dipole force component that is a Hansen solubility parameter between a charge transport material and a silane coupling agent satisfies a relationship of ΔSPa<1.0, and a difference ΔSPb in a London dispersion force component that is a Hansen solubility parameter between a resin binder and a silane coupling agent satisfies a relationship of ΔSPb<2.5, to a charge transport layer of a photoreceptor. This is thought to be because a filler contained in a charge transport layer is allowed to be uniformly dispersed by determining a material composition of a charge transport layer which causes ΔSPa and ΔSPb values to fall within the above-described ranges, and therefore, the strength of the layer is promoted, which results in the improvement of abrasion resistance.

The resin binder is preferably a polycarbonate resin or a polyarylate resin. In addition, it is preferable that the inorganic oxide filler has a primary particle size of 1 to 200 nm. Further, the charge transport material is preferably a hole transport material. The photoreceptor may have at least an undercoat layer, a charge generation layer, and the charge transport layer in that order on the conductive substrate.

Moreover, in a second aspect of the present invention, the electrophotography device may be having the above-described photoreceptor for electrophotography.

It has been revealed that by allowing a photosensitive layer to have the above-described specific charge transport layer composition, it is possible to reduce the wear loss of a photoreceptor surface while maintaining electrophotographic characteristics of a photoreceptor, thereby stably obtaining favorable images for long time, and it is also possible to improve mechanical strength according to the aspects of the present invention described above. This is thought to be because when a combination of a charge transport material, a resin binder, and a silane coupling surface treatment filler, which have uniform compatibility, is mixed in a charge transport layer, a filler contained in the layer is uniformly dispersed so that durability against abrasion due to external force applied to the photosensitive layer is improved, light permeability of the layer is also improved, and exposure light scattering is prevented, which eventually makes it possible to provide a high-quality photoreceptor having abrasion resistance and excellent image quality characteristics.

### BRIEF DESCRIPTION OF THE DRAWINGS

FIG. 1 is a schematic cross-sectional view illustrating one example of the negatively-charged functionally separate laminated type photoreceptor for electrophotography of the present invention; and

FIG. 2 is a schematic diagram illustrating one example of the electrophotography device of the present invention.

### DETAILED DESCRIPTION OF THE INVENTION

Hereinafter, specific embodiments of the photoreceptor for electrophotography of the present invention is described in detail, referring to the drawings. The present invention is not limited to the following description.

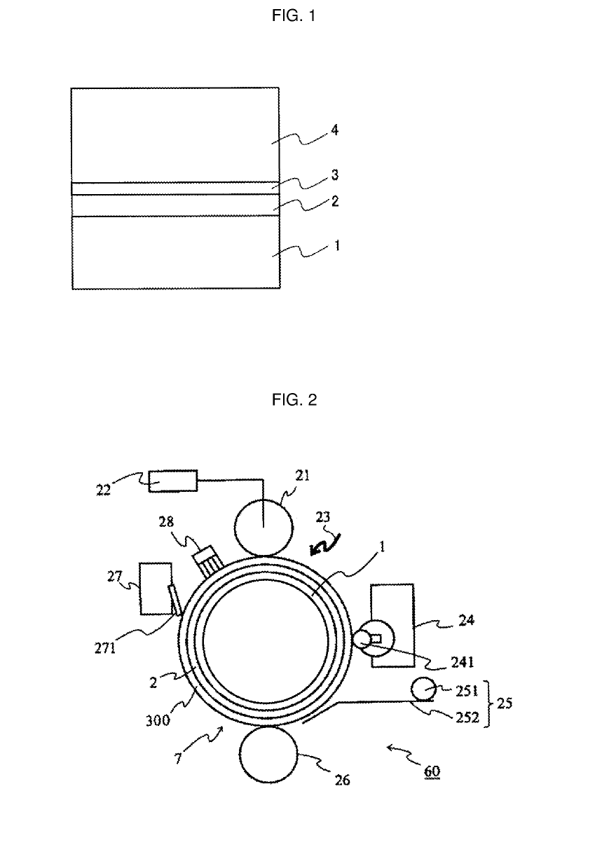

FIG. 1 is a schematic cross-sectional view illustrating one example of the photoreceptor for electrophotography of the present invention, which is a negatively charged laminated type photoreceptor for electrophotography. As illustrated, an undercoat layer 2, a charge generation layer 3 having a charge generation function, and a charge transport layer 4 having a charge transport function are laminated in that order on a conductive substrate 1 in the negatively charged laminated type photoreceptor. Here, the undercoat layer 2 may be optionally provided.

The conductive substrate 1 serves as an electrode of the photoreceptor and also serves as a support for each layer that constitutes a photoreceptor, and it may have any of a cylindrical shape, a plate shape, and a film shape. As the material of the conductive substrate 1, a metal such as aluminum, stainless steel, or nickel, glass, a resin, or the like, which has been surface-treated, can be used.

The undercoat layer 2 is made of a layer mainly comprising a resin or a metal oxide film of alumite or the like. Such undercoat layer 2 is provided as needed for the purpose of, for example, controlling ability to inject charges from the conductive substrate 1 to the photosensitive layer, covering defects on the surface of the conductive substrate 1, or improving adhesion adhesive property between the photosensitive layer and the conductive substrate 1.

Examples of the resin material used for the undercoat layer 2 include: insulating polymers such as casein, polyvinyl alcohol, polyamide, melamine, and cellulose; and conductive polymers such as polythiophene, polypyrrole, and polyaniline. These resins may be used singly or in combination, if appropriate. Further, these resins may contain a metal oxide such as titanium dioxide or zinc oxide.

The charge generation layer 3 is formed by a method such as applying a coating liquid containing particles of a charge generation material dispersed in a resin binder, and it generates charges when receiving light. It is important for the charge generation layer 3 to have high charge generation efficiency and at the same time injectability of generated charges into the charge transport layer 4. It is desirable for the charge generation layer 3 to have less electric field dependence and favorable injection performance even in a low electric field.

Examples of the charge generation material include phthalocyanine compounds such as X-type metal-free phthalocyanine, τ-type metal-free phthalocyanine, α-type titanyl phthalocyanine, β-type titanyl phthalocyanine, Y-type titanyl phthalocyanine, γ-type titanyl phthalocyanine, amorphous-type titanyl phthalocyanine, and ε-type copper phthalocyanine; various azo pigments, anthanthrone pigments, thiapyrylium pigments, perylene pigments, perinone pigments, squarylium pigments, and quinacridone pigments, which can be used singly or in appropriate combination. A suitable material can be selected depending on the light wavelength region of the exposure light source used for image formation.

As a resin binder for the charge generation layer 3, polymers and copolymers of a polycarbonate resin, a polyester resin, a polyamide resin, a polyurethane resin, a vinyl chloride resin, a vinyl acetate resin, a phenoxy resin, a polyvinyl acetal resin, a polyvinyl butyral resin, a polystyrene resin, a polysulfone resin, a diallyl phthalate resin, a methacrylic acid ester resin, and the like may be used in appropriate combination.

Note that the content of the charge generation material in the charge generation layer 3 is preferably 20% to 80% by mass and more preferably 30% to 70% by mass with respect to the solid content in the charge generation layer 3. In addition, the content of the resin binder in the charge generation layer 3 is preferably 20% to 80% by mass and more preferably 30% to 70% by mass with respect to the solid content in the charge generation layer 3.

The charge generation layer 3 is applicable as long as it has a charge generation function and its film thickness is usually 1 μm or less and preferably 0.5 μm or less. It is also possible that a charge generation layer 3 mainly comprises a charge generation material, and is used by adding a charge transport material or the like.

The charge transport layer 4 is mainly composed of a charge transport material, a resin binder, and an inorganic oxide filler surface-treated with a silane coupling agent. In the embodiments of the present invention, a composition, in which a difference ΔSPa in a dipole-dipole force component that is a Hansen solubility parameter between a charge transport material and a silane coupling agent satisfies a relationship of ΔSPa<1.0, and a difference ΔSPb in a London dispersion force component that is a Hansen solubility parameter between a resin binder and a silane coupling agent satisfies a relationship of ΔSPb<2.5, is applied to the charge transport material, the resin binder, and the filler surface-treated with a silane coupling agent of the charge transport layer 4. Accordingly, it becomes possible to promote compatibility among the charge transport material, the resin binder, and the silane coupling agent in the charge transport layer 4 that forms a surface of a photoreceptor so as to improve dispersibility of an inorganic oxide filler, thereby sufficiently reducing the wear loss of the photoreceptor surface and securing electrical properties and image characteristics. The above-described ΔSPa is preferably ΔSPa≤0.95 and the smaller ΔSPa, the more preferable. The above-described ΔSPb is preferably ΔSPb≤2.35 and the smaller ΔSPb, the more preferable.

In the embodiments of the present invention, the charge transport material used in the charge transport layer 4 is preferably a hole transport material. Specific examples of a charge transport material, a resin binder, and a silane coupling agent that can be used in the embodiments of the present invention include, but not limited to, the following charge transport materials A1 to A9, resin binders B1 to B4, and silane coupling agents C1 to C5, respectively. Of these, as a resin binder, polycarbonate resins such as bisphenol Z type polycarbonate resins and bisphenol Z type-biphenyl copolymers or polyarylate resins described below can be preferably used.

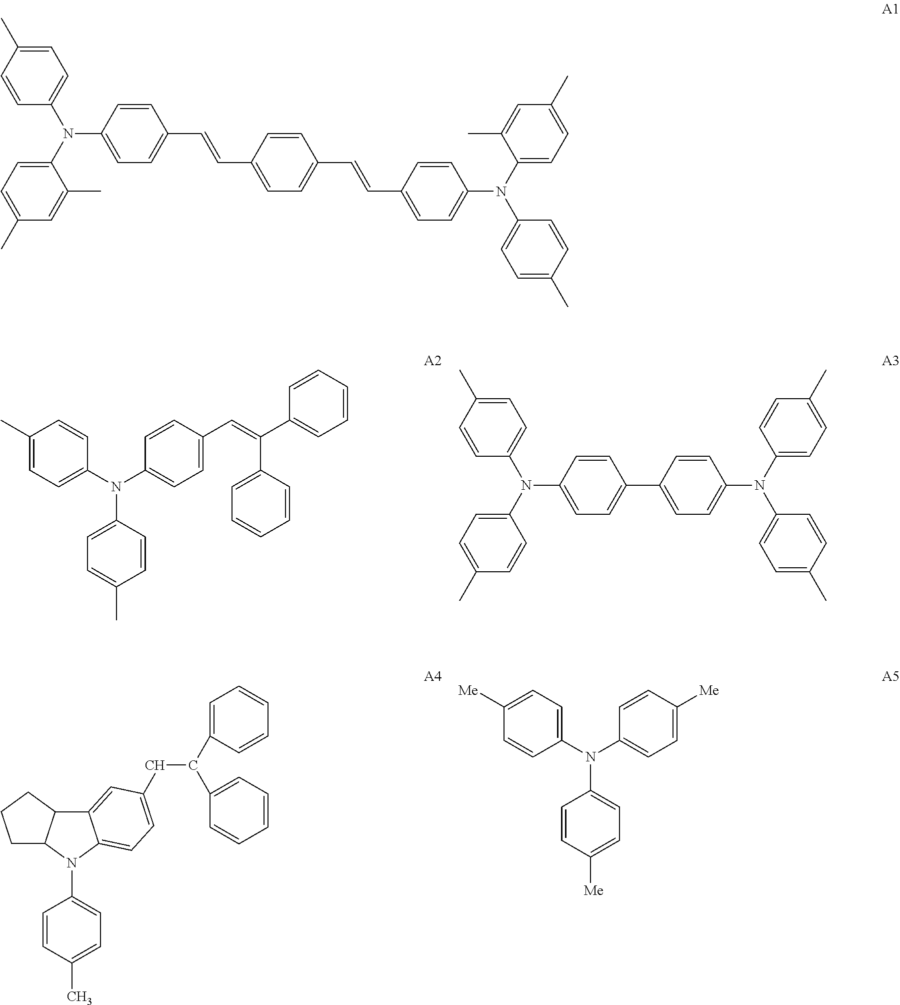

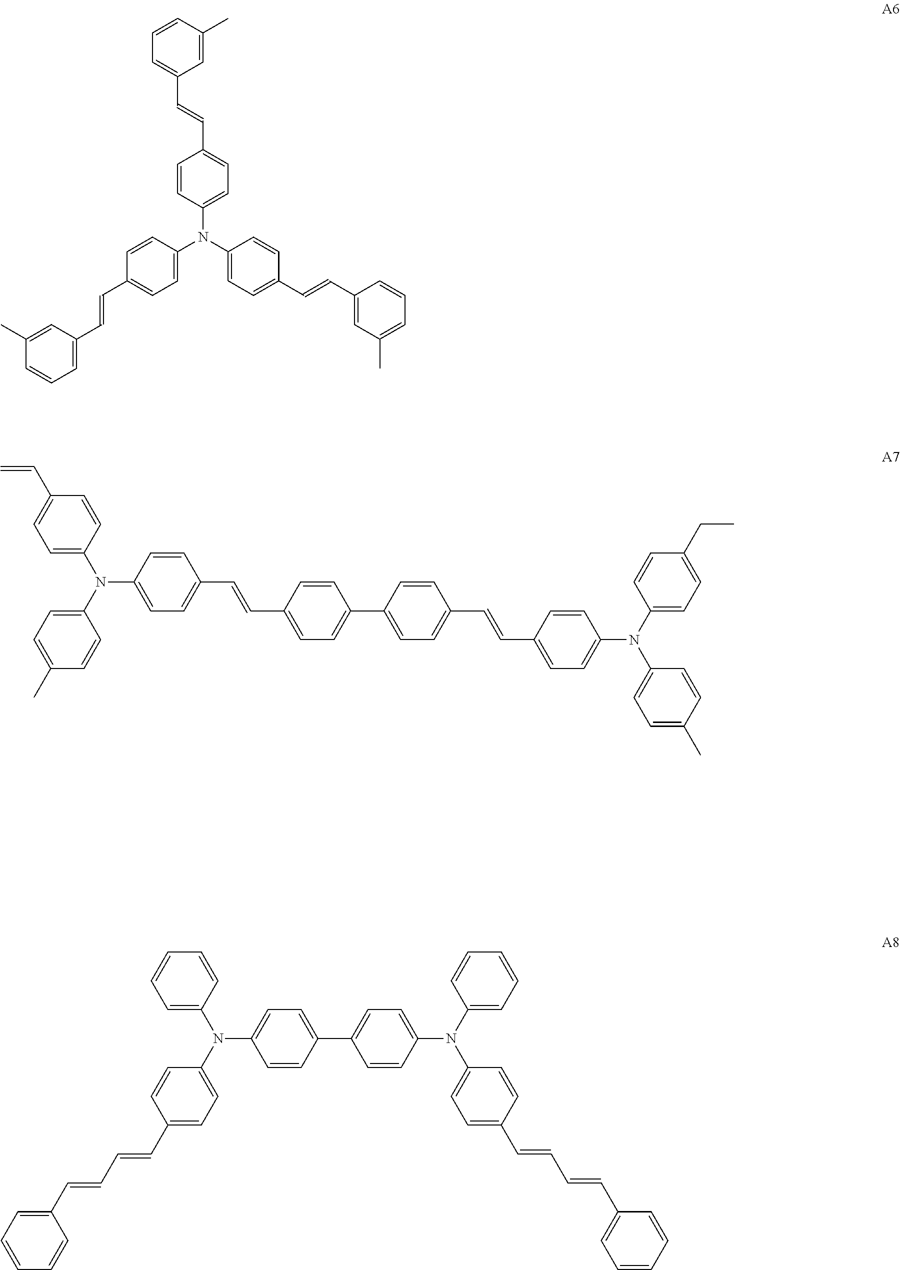 [SMILES: Cc1cccc(/C=C/c2ccc(N(c3ccc(/C=C/c4cccc(C)c4)cc3)c3ccc(/C=C/c4cccc(C)c4)cc3)cc2)c1 ; C=Cc1ccc(N(c2ccc(C)cc2)c2ccc(/C=C/c3ccc(-c4ccc(/C=C/c5ccc(N(c6ccc(C)cc6)c6ccc(CC)cc6)cc5)cc4)cc3)cc2)cc1 ; C(/C=C/c1ccc(N(c2ccccc2)c2ccc(-c3ccc(N(c4ccccc4)c4ccc(/C=C/C=C/c5ccccc5)cc4)cc3)cc2)cc1)=C\c1ccccc1]

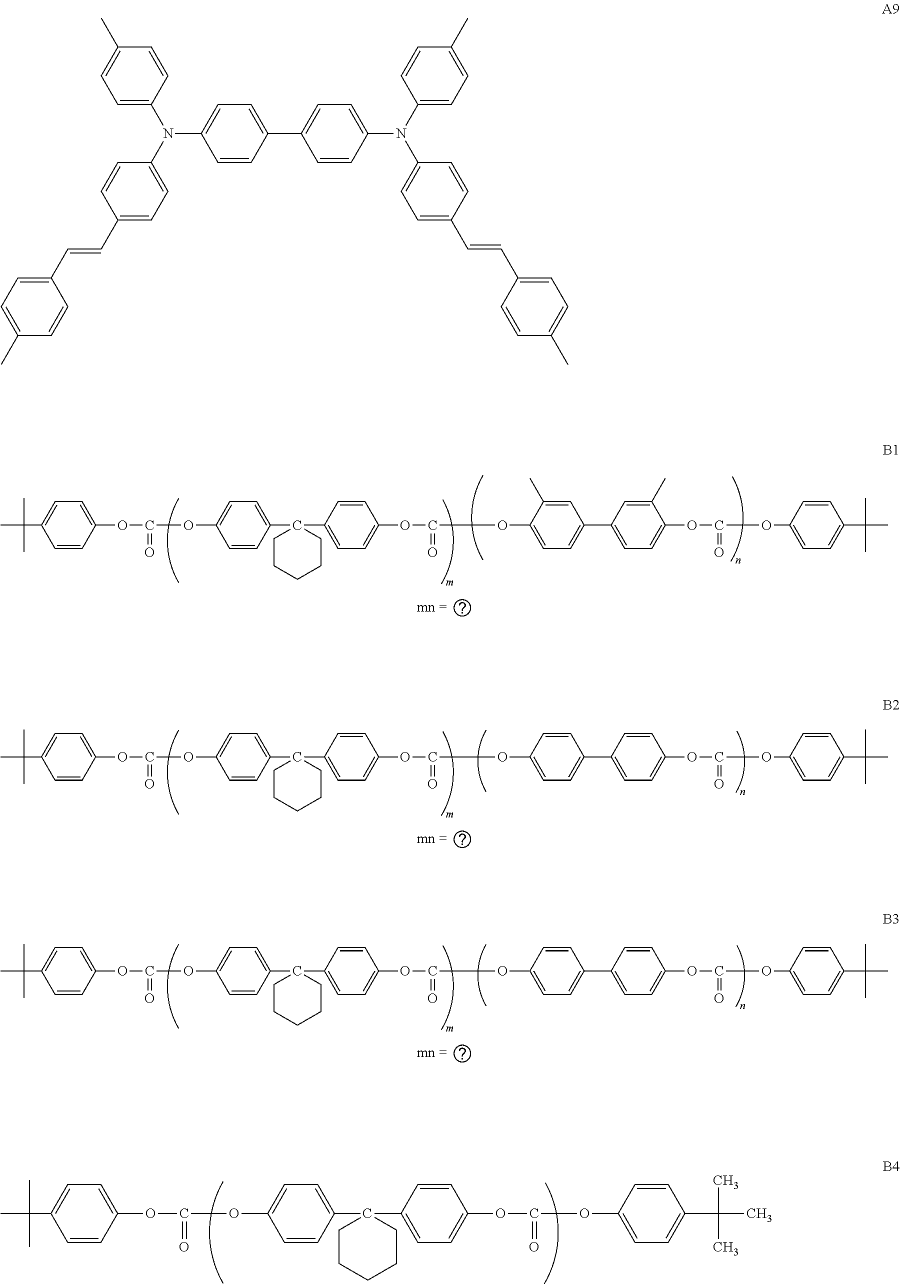

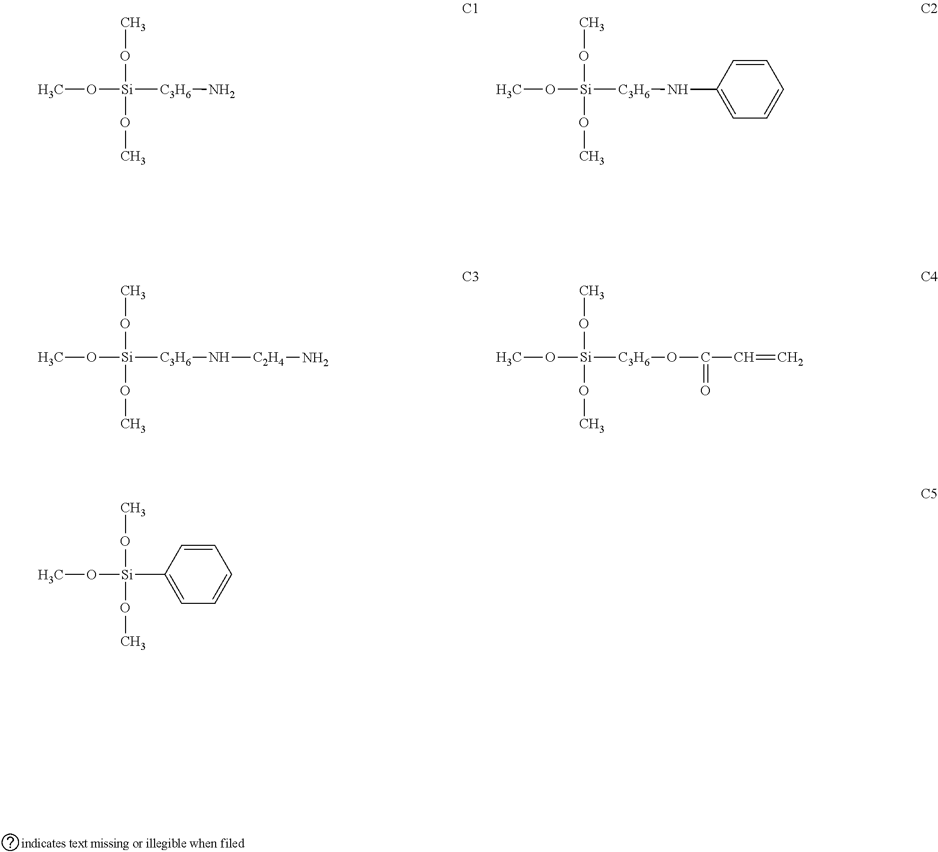

Tables 1 and 2 below list specific examples of combinations of charge transport materials A1 to A9, resin binders B1 to B4, and silane coupling agents C1 to C5 satisfying the relationship between solubility parameter differences ΔSPa and ΔSPb described above.

TABLE 1

| | Charge | | | | |
|---|---|---|---|---|---|
| Combination | transport | | Silane coupling | | |
| No. | material | Resin binder | agent | ΔSPa | ΔSPb |
| 1 | A1 | B1 | C1 | 0.85 | 1.04 |
| 2 | A1 | B1 | C2 | 0.06 | 0.85 |
| 3 | A1 | B1 | C3 | 0.38 | 2.24 |
| 4 | A1 | B2 | C2 | 0.06 | 2.35 |
| 5 | A1 | B2 | C5 | 0.89 | 1.22 |
| 6 | A1 | B3 | C1 | 0.85 | 2.20 |
| 7 | A1 | B3 | C2 | 0.06 | 2.00 |
| 8 | A1 | B3 | C5 | 0.89 | 1.57 |
| 9 | A1 | B4 | C5 | 0.89 | 1.32 |
| 10 | A2 | B1 | C1 | 0.60 | 1.04 |
| 11 | A2 | B1 | C2 | 0.19 | 0.85 |
| 12 | A2 | B1 | C3 | 0.14 | 2.24 |
| 13 | A2 | B2 | C2 | 0.19 | 2.35 |
| 14 | A2 | B2 | C4 | 0.95 | 1.62 |
| 15 | A2 | B3 | C1 | 0.60 | 2.20 |
| 16 | A2 | B3 | C2 | 0.19 | 2.00 |
| 17 | A2 | B3 | C4 | 0.95 | 1.98 |
| 18 | A2 | B4 | C4 | 0.95 | 0.91 |
| 19 | A3 | B1 | C1 | 0.27 | 1.04 |
| 20 | A3 | B1 | C2 | 0.52 | 0.85 |
| 21 | A3 | B1 | C3 | 0.19 | 2.24 |
| 22 | A3 | B2 | C2 | 0.52 | 2.35 |
| 23 | A3 | B2 | C4 | 0.62 | 1.62 |
| 24 | A3 | B3 | C1 | 0.27 | 2.20 |
| 25 | A3 | B3 | C2 | 0.52 | 2.00 |
| 26 | A3 | B3 | C4 | 0.62 | 1.98 |
| 27 | A3 | B4 | C4 | 0.62 | 0.91 |
| 28 | A4 | B1 | C1 | 0.51 | 1.04 |
| 29 | A4 | B1 | C2 | 0.27 | 0.85 |
| 30 | A4 | B1 | C3 | 0.05 | 2.24 |
| 31 | A4 | B2 | C2 | 0.27 | 2.35 |
| 32 | A4 | B2 | C4 | 0.86 | 1.62 |
| 33 | A4 | B3 | C1 | 0.51 | 2.20 |
| 34 | A4 | B3 | C2 | 0.27 | 2.00 |
| 35 | A4 | B3 | C4 | 0.86 | 1.98 |
| 36 | A4 | B4 | C4 | 0.86 | 0.91 |
| 37 | A5 | B1 | C1 | 0.29 | 1.04 |
| 38 | A5 | B1 | C3 | 0.76 | 2.24 |

TABLE 2

| | Charge | | | | |
|---|---|---|---|---|---|
| Combination | transport | | Silane coupling | | |
| No. | material | Resin binder | agent | ΔSPa | ΔSPb |
| 39 | A5 | B2 | C4 | 0.05 | 1.62 |
| 40 | A5 | B3 | C1 | 0.29 | 2.20 |
| 41 | A5 | B3 | C4 | 0.05 | 1.98 |
| 42 | A5 | B4 | C4 | 0.05 | 0.91 |
| 43 | A6 | B1 | C2 | 0.34 | 0.85 |
| 44 | A6 | B1 | C3 | 0.67 | 2.24 |
| 45 | A6 | B2 | C2 | 0.34 | 2.35 |
| 46 | A6 | B2 | C5 | 0.60 | 1.22 |
| 47 | A6 | B3 | C2 | 0.34 | 2.00 |
| 48 | A6 | B3 | C5 | 0.60 | 1.57 |
| 49 | A6 | B4 | C5 | 0.60 | 1.32 |
| 50 | A7 | B1 | C1 | 0.91 | 1.04 |
| 51 | A7 | B1 | C2 | 0.13 | 0.85 |
| 52 | A7 | B1 | C3 | 0.45 | 2.24 |
| 53 | A7 | B2 | C2 | 0.13 | 2.35 |
| 54 | A7 | B2 | C5 | 0.82 | 1.22 |
| 55 | A7 | B3 | C1 | 0.91 | 2.20 |
| 56 | A7 | B3 | C2 | 0.13 | 2.00 |
| 57 | A7 | B3 | C5 | 0.82 | 1.57 |
| 58 | A7 | B4 | C5 | 0.82 | 1.32 |
| 59 | A8 | B1 | C1 | 0.83 | 1.04 |
| 60 | A8 | B1 | C2 | 0.05 | 0.85 |
| 61 | A8 | B1 | C3 | 0.37 | 2.24 |
| 62 | A8 | B2 | C2 | 0.05 | 2.35 |
| 63 | A8 | B2 | C5 | 0.90 | 1.22 |
| 64 | A8 | B3 | C1 | 0.83 | 2.20 |
| 65 | A8 | B3 | C2 | 0.05 | 2.00 |
| 66 | A8 | B3 | C5 | 0.90 | 1.57 |
| 67 | A8 | B4 | C5 | 0.90 | 1.32 |
| 68 | A9 | B1 | C1 | 0.84 | 1.04 |
| 69 | A9 | B1 | C2 | 0.05 | 0.85 |
| 70 | A9 | B1 | C3 | 0.38 | 2.24 |
| 71 | A9 | B2 | C2 | 0.05 | 2.35 |
| 72 | A9 | B2 | C5 | 0.89 | 1.22 |
| 73 | A9 | B3 | C1 | 0.84 | 2.20 |
| 74 | A9 | B3 | C2 | 0.05 | 2.00 |
| 75 | A9 | B3 | C5 | 0.89 | 1.57 |
| 76 | A9 | B4 | C5 | 0.89 | 1.32 |

In addition, the weight-average molecular weight of the above-described resin binder is preferably 5,000 to 250,000 and more preferably 10,000 to 200,000 in terms of polystyrene conversion upon gel permeation chromatography (GPC) analysis.

In the embodiments of the present invention, the charge transport layer 4 contains an inorganic oxide filler surface-treated with a silane coupling agent. Examples of the inorganic oxide filler include alumina, zirconia, titanium oxide, tin oxide, and zinc oxide and the like besides those containing silica as a main component, and these typically have a hydroxyl group on the surface at the time of use. When an inorganic oxide filler is directly mixed in a coating liquid as it is, inorganic oxide filler particles tend to aggregate. However, by surface-treating the inorganic oxide with a silane coupling agent, it is possible to allow the silane coupling agent to bind to hydroxyl groups on the inorganic oxide surface, thereby reducing aggregability of the inorganic oxide itself, and it is also possible to improve compatibility with the resin binder and the charge transport material in the coating liquid. However, even with an inorganic oxide filler surface-treated with a silane coupling agent, hydroxyl groups may remain on the surface depending on the degree of surface treatment, which causes aggregation.

Among the above, inorganic oxides mainly comprising silica are preferable as inorganic oxides. As a method of producing, silica particles having a particle diameter of about several nanometers to several tens of nanometers as silica, a method called a wet process of producing silica using water glass as a starting material, a method called a dry process in which chlorosilane or the like is allowed to react in a gas phase, and a method using, as a starting material, alkoxide serving as a silica precursor are known.

Here, in a case in which different types of metals are present as impurities in large amounts when silica is surface-treated, defects are generated due to the metals having unusual oxide portions, which causes a surface potential distribution to vary and increase aggregability of oxide particles starting at such portions. This eventually causes increased aggregates in the coating liquid or the photosensitive layer. Therefore, it is preferable that silica has high purity. Accordingly, it is preferable to control the content of a metal other than metal elements that constitute an inorganic oxide to 1000 ppm or less for each metal element.

Meanwhile, in order to allow a surface treatment agent to sufficiently react so as to improve activity of the silica surface, it is preferable to add a trace amount of a metal of a different type. The surface treatment agent reacts with hydroxyl groups present on the silica surface. However, in a case in which silica contains a trace amount of a different metal element, reactivity of silanol groups (hydroxyl groups) adjacent to the different metal element present on the silica surface is improved due to the influence of the difference in electronegativity between metals. Since the hydroxyl groups are highly reactive with a surface treatment agent, they react with the surface treatment agent more strongly than other hydroxyl groups, however, when they remain, they cause aggregation. It is considered that after these reactions of the surface treatment agents, the surface treatment agent reacts with other hydroxyl groups, which results in significant improvement in aggregability of silica particles due to the effects of the surface treatment agent and the effect of reducing bias of the surface charge caused by different types of metals on the surface. In the embodiments of the present invention, in a case in which an inorganic oxide contains minute amounts of other metals, reactivity of the surface treatment is improved, which eventually results in the increase of dispersibility due to surface treatment, which is preferable. It can be said that the improvement of aggregability in the presence of different types of metals as impurities in large amounts and the improvement of dispersibility due to the presence of other metals contained in trace amounts described above are caused by different mechanisms.

Regarding silica, the addition of an aluminum element at a concentration of 1000 ppm or less is preferable for surface treatment. The amount of an aluminum element in silica can be adjusted by the method described in, for example, Japanese Unexamined Patent Application Publication Nos. 2004-143028 A and 2013-224225. However, as long as the amount can be controlled within a desired scope, the adjustment method is not particularly limited.

Specifically, for example, the following methods are available as a method of preferably controlling the amount of an aluminum element on the silica surface. A first example is a method of controlling the amount of aluminum on the silica surface by, for example, adding aluminum alkoxide serving as an aluminum source after allowing silica particles to grow to have a shape with a silica particle diameter smaller than the desired particle diameter upon production of silica fine particles. In addition, there are a method, in which silica fine particles are added to a solution containing aluminum chloride so as to coat the surfaces of the silica fine particles with the aluminum chloride solution, and the coating is dried and calcined, and a method, in which a mixed gas of a halogenated aluminum compound and a halogenated silicon compound is allowed to react.

In addition, it is known that in the structure of silica, a plurality of silicon atoms and oxygen atoms are connected to form a cyclic shape such that a mesh-like bond structure is established. In a case in which silica contains an aluminum element, the number of atoms constituting the cyclic structure of silica is greater than that of normal silica due to the effect of adding aluminum. As a result of this effect, steric hindrance that occurs upon reaction of the surface treatment for hydroxyl groups on the surface of silica containing an aluminum element agent is attenuated as compared with the normal silica surface. This allows the surface treatment agent to have improved reactivity, thereby obtaining surface-treated silica having improved dispersibility, compared with a case in which the same surface treatment agent is allowed to react with normal silica.

In order to provide the effects in the embodiments of the present invention, silica obtained by the wet method is more preferable for controlling the aluminum element amount. In addition, the content of an aluminum element in silica is preferably 1 ppm or more in consideration of reactivity of the surface treatment agent.

Although the form of the inorganic oxide is not particularly limited, sphericity of the inorganic oxide is preferably 0.8 or more and more preferably 0.9 or more in order to obtain a uniform dispersion state by reducing aggregability.

Further, when using the inorganic oxide in the charge transport layer of the photoreceptor for which high resolution is expected, it is preferable to consider an impact of α-ray or the like derived from a material added to the charge transport layer. In an example of a semiconductor memory device, the memory device retains a type of data to be stored depending on the presence/absence of accumulation of charge, however, due to miniaturization, the size of accumulated charges also decreases such that the charges may change by an α ray emitted from the outside, thereby the type of data may vary resulting in unexpected changes in data. Further, since the amount of the current flowing through the semiconductor device decreases is small, the current (noise) generated from the α-ray becomes relatively large as compared with the size of signals, which might cause malfunction. As in the case of such phenomenon, when considering the influence on the movement of charges in the charge transport layer of the photoreceptor, it is more preferable to use a material that is less likely to cause generation of α-rays in the film constituting material. Specifically, it is effective to reduce the concentration of uranium or thorium in an inorganic oxide. The concentration of thorium is preferably 30 ppb or less, and the concentration of uranium is preferably 1 ppb or less. A method of reducing the uranium or thorium content in an inorganic oxide is described in, for example, Japanese Unexamined Patent Application Publication No. 2013-224225. As long as the concentrations of these elements can be reduced, the present invention is not limited to this method.

The primary particle size of the inorganic oxide filler is not particularly limited, however, it is preferably 1 to 200 nm, more preferably 5 to 100 nm and further preferably 10 to 50 nm. In a case in which the primary particle size of the inorganic oxide filler is less than 1 nm, the dispersion state might become uneven due to aggregation.

Meanwhile, in a case in which the primary particle size of the inorganic oxide filler exceeds 200 nm, the degree of light scattering increases, which might cause image loss. Note that the primary particle size is the number average diameter measured using a scanning microscope that allows direct observation of the particle surface shape.

The content of a surface-treated inorganic oxide filler in the charge transport layer 4 is 1 to 40% by mass and more preferably 2 to 30% by mass with respect to the solid content of the charge transport layer 4. The content of a resin binder in the charge transport layer 4 is preferably 20 to 90% by mass and more preferably 30 to 80% by mass with respect to the solid content of the charge transport layer 4 excluding the inorganic oxide filler.

The content of a charge transport material in the charge transport layer 4 is preferably 10 to 80% by mass and more preferably 20 to 70% by mass with respect to the solid content of the charge transport layer 4 excluding the inorganic oxide filler.

Further, the film thickness of the charge transport layer 4 is preferably 3 to 50 μm and more preferably 15 to 40 μm in order to maintain a practically effective surface potential.

In the embodiments of the present invention, the charge generation layer 3 and the charge transport layer 4 may contain deterioration inhibitors such as an antioxidant and a light stabilizer for the purpose of improving environmental resistance or stability against harmful light, if desired. Examples of compounds used for such purpose include: chromanol derivatives such as tocopherol, ester compounds, polyaryl alkane compounds, hydroquinone derivatives, ether compounds, diether compounds, benzophenone derivatives, benzotriazole derivatives, thioether compounds, phenylenediamine derivatives, phosphonic acid esters, phosphorous acid esters, phenol compounds, hindered phenol compounds, straight chain amine compounds, cyclic amine compounds, and hindered amine compounds.

Further, the charge generation layer 3 and the charge transport layer 4 may also contain a leveling agent such as silicone oil or fluorine oil for the purpose of improving the leveling ability of the formed film or imparting lubricity. Moreover, for the purpose of, for example, adjusting film hardness, reducing the friction coefficient, or imparting lubricity, metal oxides such as silicon oxide (silica), titanium oxide, zinc oxide, calcium oxide, aluminum oxide (alumina), and zirconium oxide, metal sulfates such as barium sulfate and calcium sulfate, fine particles of a metal nitride such as silicon nitride and aluminum nitride, fluorine resin particles of polytetrafluoroethylene or the like, a fluorinated comb type graft polymerization resin, or the like may be contained. Furthermore, if necessary, it is possible to add other known additives unless electrophotographic characteristics are seriously impaired.

By applying the photoreceptor for electrophotography in the embodiments of the present invention to various machine processes, desired effects can be obtained. Specifically, sufficient effects can be obtained also in a charging process such as a contact charging method in which a charging member such as a roller or a brush is used and a non-contact charging method in which corotron or scorotron is used, as well as in a developing process such as a contact developing method and a non-contact developing method in which non-magnetic single component, magnetic single component, or two-component developing system (developer) is employed.

Electrophotography Device

The electrophotography device in the embodiments of the present invention is characterized in that the photoreceptor for electrophotography in the embodiments of the present invention described above is mounted therewith. FIG. 2 is a schematic diagram illustrating one example of the electrophotography device of the present invention. An illustrated electrophotography device 60 in the embodiments of the present invention is equipped with a photoreceptor 7 in the embodiments of the present invention, which includes a conductive substrate 1 and an undercoat layer 2 that covers the outer peripheral face thereof, and a photosensitive layer 300. The electrophotography device 60 is composed of a roller-shaped (in the illustrated example) charging member 21 disposed on the outer periphery of the photoreceptor 7, a high-voltage power supply 22 for supplying applied voltage to the charging member 21, an image exposure member 23, a developing unit 24 equipped with a developing roller 241, a paper feeding member 25 equipped with a paper feeding roller 251 and a paper feeding guide 252, and a transfer charger (direct charge type) 26. The electrophotography device 60 may further include a cleaning unit 27 equipped with a cleaning blade 271 and a neutralizing member 28. Here, the electrophotography device 60 in the embodiments of the present invention may be a color printer.

### EXAMPLES

Hereinafter, specific aspects of the present invention are explained in more detail with reference to the Examples. The present invention is not limited to the Examples below within the scope of the subject matter of the invention.

Production of Negatively Charged Laminated Type Photoreceptor:

### Example 1

In 90 parts by mass of methanol, 5 parts by mass of alcohol-soluble nylon (trade name: “CM8000” manufactured by Toray Industries, Inc.) and 5 parts by mass of aminosilane-treated titanium oxide fine particles were dissolved and dispersed, thereby preparing a coating liquid 1. The outer periphery of an aluminum-made cylinder serving as a conductive substrate 1 having an outer diameter of 30 mm was dip-coated with the coating liquid 1 and dried at a temperature of 100° C. for 30 minutes, thereby forming an undercoat layer 2 having a film thickness of 3 μm.

Next, 1 part by mass of Y type titanyl phthalocyanine serving as a charge generation material and 1.5 parts by mass of a polyvinyl butyral resin (trade name: “S-LEC BM-2” manufactured by Sekisui Chemical Co., Ltd.) serving as a resin binder were dissolved and dispersed in 60 parts by mass of dichloromethane, thereby preparing a coating liquid 2. The above-described undercoat layer 2 was dip-coated with the coating liquid 2 and dried at a temperature of 80° C. for 30 minutes, thereby forming a charge generation layer 3 having a film thickness of 0.3 μm.

Next, as a charge transport material, 9 parts by mass of a compound (A1) represented by the following structural formula (I-1):

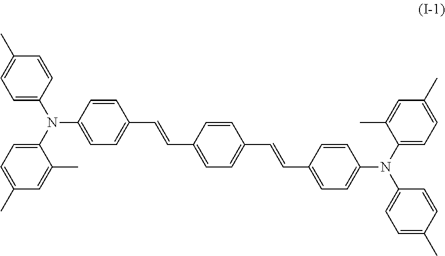 [SMILES: Cc1ccc(N(c2ccc(/C=C/c3ccc(/C=C/c4ccc(N(c5ccc(C)cc5)c5ccc(C)cc5C)cc4)cc3)cc2)c2ccc(C)cc2C)cc1]

and, as a resin binder, 11 parts by mass of a resin (B1) having a repeating unit represented by the following structural formula (II-1):

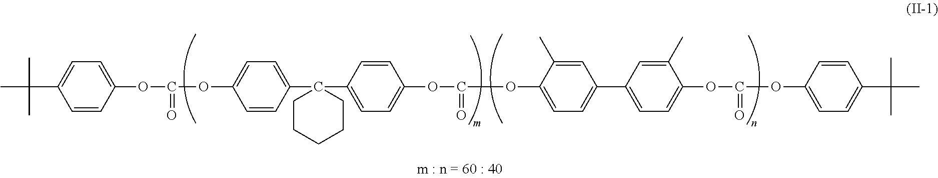

were dissolved in 80 parts by mass of tetrahydrofuran.

In the resulted liquid, as an inorganic oxide filler surface-treated with a silane coupling agent, 5 parts by weight of surface-treated silica, which was obtained by surface-treating silica (YA010C; aluminum element content: 500 ppm) manufactured by Admatechs Company Limited with a silane coupling agent (C2) represented by the following structural formula (III-1), was mixed and dispersed in the resulting liquid, thereby preparing a coating liquid 3:

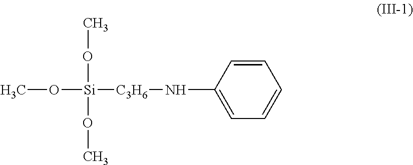

The above-described charge generation layer 3 was dip-coated with the coating liquid 3 and dried at a temperature of 120° C. for 60 minutes, thereby forming a charge transport layer 4 having a film thickness of 20 μm, thereby preparing a negatively charged laminated type photoreceptor.

### Example 2

A photoreceptor was produced in the same manner as in Example 1 except that the resin binder (B1) represented by structural formula (II-1) used in Example 1 was changed to a resin binder (B2) represented by the following structural formula (II-2):

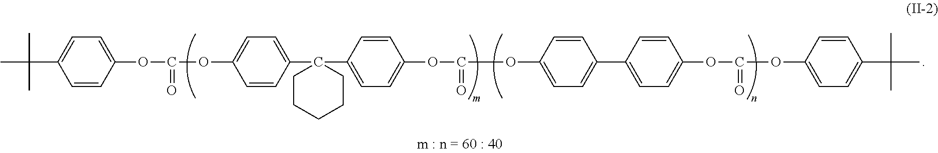

### Example 3

A photoreceptor was produced in the same manner as in Example 1 except that the resin binder (B1) represented by structural formula (II-1) was used in Example 1 was changed to a resin binder (B3) represented by the following structural formula (II-3):

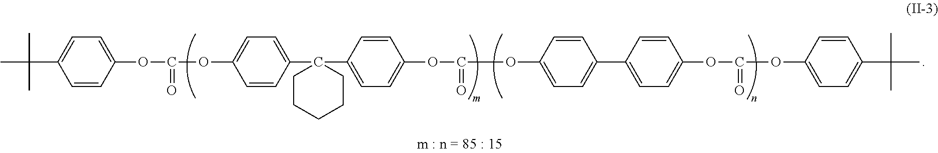

### Example 4

A photoreceptor was produced in the same manner as in Example 1 except that the charge transport material (A1) represented by structural formula (I-1) used in Example 1 was changed to a charge transport material (A2) represented by the following structural formula (I-2):

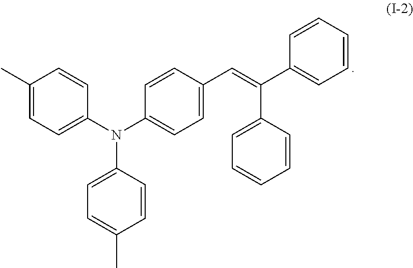 [SMILES: Cc1ccc(N(c2ccc(C)cc2)c2ccc(C=C(c3ccccc3)c3ccccc3)cc2)cc1]

### Example 5

A photoreceptor was produced in the same manner as in Example 1 except that the charge transport material (A1) represented by structural formula (I-1) used in Example 1 was changed to a charge transport material (A3) represented by the following structural formula (I-3):

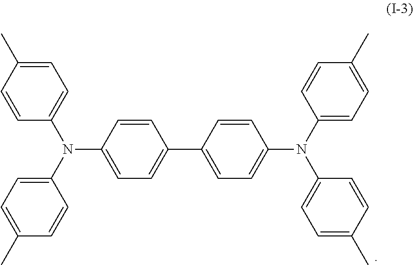 [SMILES: Cc1ccc(N(c2ccc(C)cc2)c2ccc(-c3ccc(N(c4ccc(C)cc4)c4ccc(C)cc4)cc3)cc2)cc1]

### Example 6

A photoreceptor was produced in the same manner as in Example 1 except that the charge transport material (A1) represented by structural formula (I-1) used in Example 1 was changed to a charge transport material (A7) represented by the following structural formula (I-4):

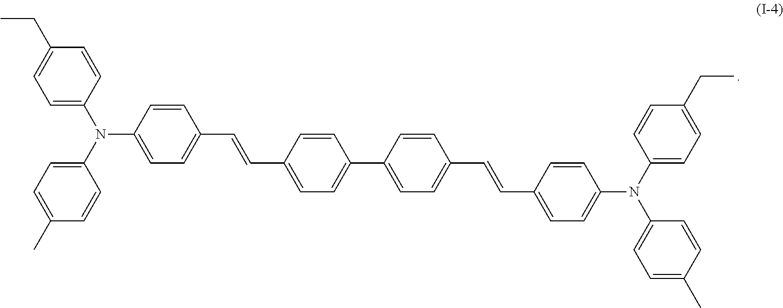 [SMILES: CCc1ccc(N(c2ccc(C)cc2)c2ccc(/C=C/c3ccc(-c4ccc(/C=C/c5ccc(N(c6ccc(C)cc6)c6ccc(CC)cc6)cc5)cc4)cc3)cc2)cc1]

### Example 7

A photoreceptor was produced in the same manner as in Example 1 except that the charge transport material (A1) represented by structural formula (I-1) used in Example 1 was changed to a charge transport material (A8) represented by the following structural formula (I-5):

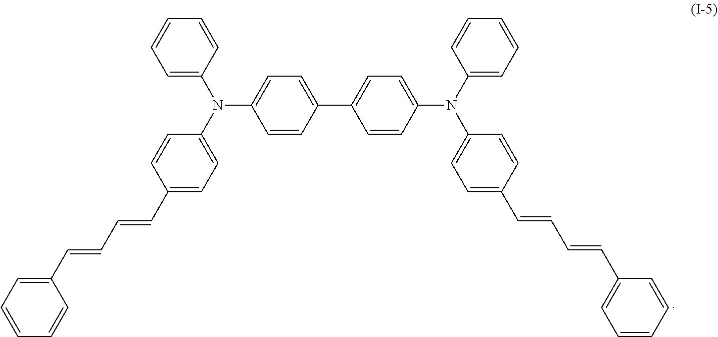 [SMILES: C(/C=C/c1ccc(N(c2ccccc2)c2ccc(-c3ccc(N(c4ccccc4)c4ccc(/C=C/C=C/c5ccccc5)cc4)cc3)cc2)cc1)=C\c1ccccc1]

### Example 8

A photoreceptor was produced in the same manner as in Example 1 except that the charge transport material (A1) represented by structural formula (I-1) used in Example 1 was changed to a charge transport material (A9) represented by the following structural formula (I-6):

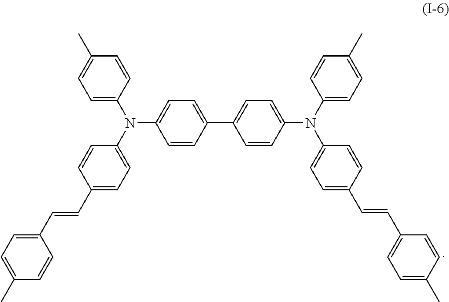 [SMILES: Cc1ccc(/C=C/c2ccc(N(c3ccc(C)cc3)c3ccc(-c4ccc(N(c5ccc(C)cc5)c5ccc(/C=C/c6ccc(C)cc6)cc5)cc4)cc3)cc2)cc1]

### Example 9

A photoreceptor was produced in the same manner as in Example 1 except that the silane coupling agent (C2) represented by structural formula (III-1) used in Example 1 was changed to a silane coupling agent (C3) represented by the following structural formula (III-2):

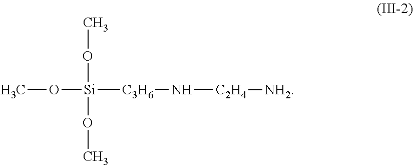

### Example 10

A photoreceptor was produced in the same manner as in Example 1 except that the charge transport material (A1) represented by structural formula (I-1) used in Example 1 was changed to a charge transport material (A2) represented by the following structural formula (I-2):

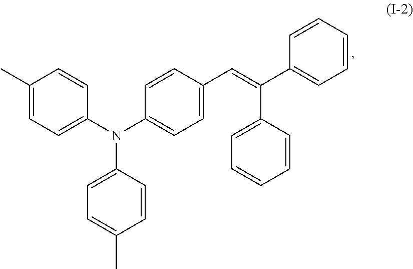 [SMILES: Cc1ccc(N(c2ccc(C)cc2)c2ccc(C=C(c3ccccc3)c3ccccc3)cc2)cc1]

the resin binder (B1) represented by structural formula (II-1) was changed to a resin binder (B2) represented by the following structural formula (II-2):

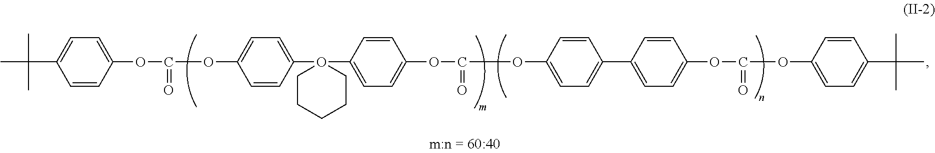

and the silane coupling agent (C2) represented by structural formula (III-1) was changed to a silane coupling agent (C4) represented by the following structural formula (III-3):

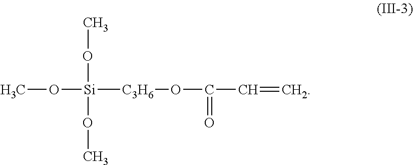

### Example 11

A photoreceptor was produced in the same manner as in Example 1 except that the resin binder (B1) represented by structural formula (II-1) used in Example 1 was changed to a resin binder (B2) represented by the following structural formula (II-2):

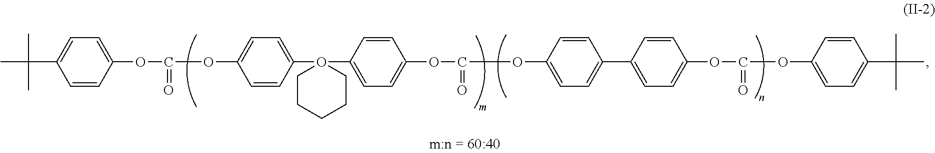

and the silane coupling agent (C2) represented by structural formula (III-1) was changed to a silane coupling agent (C5) represented by the following structural formula (III-4):

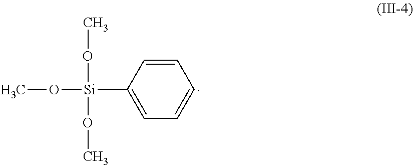

### Example 12

A photoreceptor was produced in the same manner as in Example 1 except that the resin binder (B1) represented by structural formula (II-1) used in Example 1 was changed to a resin binder (B4) represented by the following structural formula (II-4):

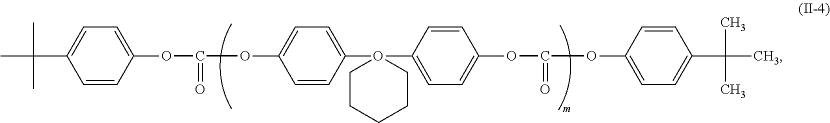

and the silane coupling agent (C2) represented by structural formula (III-1) was changed to a silane coupling agent (C5) represented by the following structural formula (III-4):

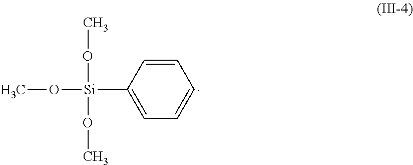

### Comparative Example 1

A photoreceptor was produced in the same manner as in Example 1 except that the silane coupling agent (C2) represented by structural formula (III-1) used in Example 1 was changed to a silane coupling agent represented by the following structural formula (III-5):

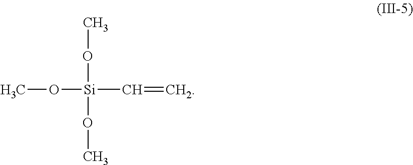

### Comparative Example 2

A photoreceptor was produced in the same manner as in Example 1 except that the silane coupling agent (C2) represented by structural formula (III-1) used in Example 1 was changed to a silane coupling agent represented by the following structural formula (III-6):

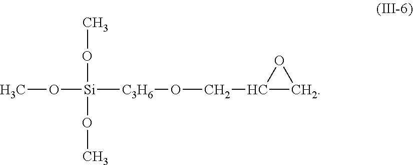

### Comparative Example 3

A photoreceptor was produced in the same manner as in Example 1 except that the silane coupling agent (C2) represented by structural formula (III-1) used in Example 1 was changed to a silane coupling agent represented by the following structural formula (III-7):

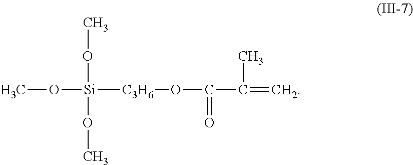

### Comparative Example 4

A photoreceptor was produced in the same manner as in Example 1 except that the silane coupling agent (C2) represented by structural formula (III-1) used in Example 1 was changed to a charge transport material represented by the following structural formula (III-8):

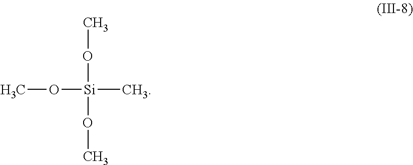

### Comparative Example 5

A photoreceptor was produced in the same manner as in Example 3 except that the silane coupling agent (C2) represented by structural formula (III-1) used in Example 3 was changed to a silane coupling agent (C3) represented by the following structural formula (III-2):

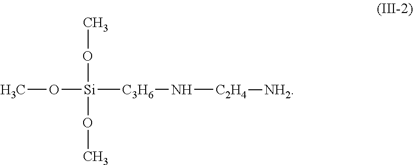

### Comparative Example 6

A photoreceptor was produced in the same manner as in Example 1 except that the surface-treated silica used in Example 1, which was surface-treated with a silane coupling agent, was not added.

For the photoreceptors prepared in Examples 1 to 12 and Comparative Examples 1 to 6 above, values of the difference ΔSPa in the dipole-dipole force component that is a Hansen solubility parameter between a charge transport material and a silane coupling agent and values of the difference ΔSPb in the London dispersion force component that is a Hansen solubility parameter between a resin binder and a silane coupling agent were obtained. The results are listed with the compositions of the respective photoreceptors in Table 3 below.

Evaluation of Photoreceptor

Electrical properties of the photoreceptors prepared in Examples 1 to 12 and Comparative Examples 1 to 6 described above were evaluated according to the following method. Evaluation results obtained are listed in Table 4 below.

Electrical Properties

Electrical properties of the photoreceptors obtained in the Examples and the Comparative Examples were evaluated by the following method using a process simulator (CYNTHIA91) manufactured by GENTECH CO., LTD. For the photoreceptors of Examples 1-12 and Comparative Examples 1-6, the surface of each photoreceptor was charged to −650V by corona discharge in the dark in an environment at a temperature 22° C. and a humidity of 50%, and then, surface potential V0 immediately after charging was measured. Subsequently, the photoreceptor was left for 5 seconds in the dark, and then, surface potential V5 was measured. The potential retention rate Vk5 (%) at 5 seconds after charging was determined in accordance with the following calculation formula (1):

Vk5=V5/V0×100 (1).

Next, using a halogen lump as a light source, exposure light of 1.0 μW/cm² spectroscopically dispersed at 780 nm light using a filter, was irradiated to the photoreceptor for 5 seconds when the surface potential reached −600V. After that, the amount of exposure light required for light attenuation until the surface potential reached −300V, expressed as E1/2 (μJ/cm2) and the residual potential on the photoreceptor surface at 5 seconds after light exposure, expressed as Vr5 (V) were evaluated.

Actual Device Characteristics

Each of the photoreceptors prepared in Examples 1 to 12 and Comparative Examples 1 to 6 was mounted on a HP Printer LJ4050, which was modified to allow measurement of the photoreceptor surface potential, and 10,000 sheets of A4 paper were printed. The film thickness of each photoreceptor was measured before and after printing, and evaluation of average wear loss (μm) after printing was conducted. The average wear loss was obtained by measuring film thickness at four points determined by rotating the longitudinal center of the photoreceptor (130 mm from either end) by 90° in the circumferential direction and averaging the measured values. In addition, fog and black density on white paper were observed at the initial stage and after printing of 10,000 sheets. A case in which no fog and density decrease was observed was determined to be favorable.

TABLE 3

| | Inorganic oxide | | | | | | |
|---|---|---|---|---|---|---|---|
| | filler | | | | | | |
| | | Primary | Surface | Charge | | | |
| | | particle | treat- | trans- | | | |
| | | size | ment | port | Resin | | |
| | Type | (mm) | agent | material | binder | ΔSPa | ΔSPb |
| Example 1 | Silica | 10 | III-1 | I-1 | II-1 | 0.06 | 0.85 |
| Example 2 | Silica | 10 | III-1 | I-1 | II-2 | 0.06 | 2.35 |
| Example 3 | Silica | 10 | III-1 | I-1 | II-3 | 0.06 | 2.00 |
| Example 4 | Silica | 10 | III-1 | I-2 | II-1 | 0.19 | 0.85 |
| Example 5 | Silica | 10 | III-1 | I-3 | II-1 | 0.52 | 0.85 |
| Example 6 | Silica | 10 | III-1 | I-4 | II-1 | 0.13 | 0.85 |
| Example 7 | Silica | 10 | III-1 | I-5 | II-1 | 0.05 | 0.85 |
| Example 8 | Silica | 10 | III-1 | I-6 | II-1 | 0.05 | 0.85 |
| Example 9 | Silica | 10 | III-2 | I-1 | II-1 | 0.38 | 2.24 |
| Example 10 | Silica | 10 | III-3 | I-2 | II-2 | 0.95 | 1.62 |
| Example 11 | Silica | 10 | III-4 | I-1 | II-2 | 0.89 | 1.22 |
| Example 12 | Silica | 10 | III-4 | I-1 | II-4 | 0.89 | 1.32 |
| Comparative | Silica | 10 | III-5 | I-1 | II-1 | 1.63 | 2.67 |
| Example 1 | | | | | | | |
| Comparative | Silica | 10 | III-6 | I-1 | II-1 | 3.75 | 2.10 |
| Example 2 | | | | | | | |
| Comparative | Silica | 10 | III-7 | I-1 | II-1 | 4.36 | 1.02 |
| Example 3 | | | | | | | |
| Comparative | Silica | 10 | III-8 | I-1 | II-1 | 1.63 | 6.88 |
| Example 4 | | | | | | | |
| Comparative | Silica | 10 | III-2 | I-1 | II-3 | 0.38 | 3.39 |
| Example 5 | | | | | | | |
| Comparative | — | — | — | I-1 | II-1 | — | — |
| Example 6 | | | | | | | |

TABLE 4

| | Electrical properties | | | | | |
|---|---|---|---|---|---|---|
| | Charge | | | Average | Image characteristics | |
| | retention | Sensitivity | Residual | wear | | After print |
| | rate Vk5 | E1/2 | potential | loss | Initial | durability |
| | (%) | (μJ/cm²) | Vr5 (V) | (μm) | stage | test |
| Example 1 | 93.4 | 0.16 | 25 | 1.4 | Favorable | Favorable |
| Example 2 | 92.8 | 0.16 | 23 | 1.4 | Favorable | Favorable |
| Example 3 | 92.3 | 0.16 | 21 | 1.6 | Favorable | Favorable |
| Example 4 | 92.9 | 0.16 | 23 | 1.4 | Favorable | Favorable |
| Example 5 | 92.4 | 0.15 | 24 | 1.5 | Favorable | Favorable |
| Example 6 | 91.7 | 0.16 | 23 | 1.4 | Favorable | Favorable |
| Example 7 | 92.0 | 0.15 | 25 | 1.5 | Favorable | Favorable |
| Example 8 | 92.5 | 0.17 | 23 | 1.5 | Favorable | Favorable |
| Example 9 | 93.1 | 0.16 | 24 | 1.6 | Favorable | Favorable |
| Example 10 | 91.9 | 0.15 | 22 | 1.5 | Favorable | Favorable |
| Example 11 | 92.6 | 0.16 | 24 | 1.5 | Favorable | Favorable |
| Example 12 | 92.4 | 0.17 | 23 | 1.5 | Favorable | Favorable |
| Comparative | 76.8 | 3.9 | 79 | 3.4 | Fog | Fog/Print |
| Example 1 | | | | | | density |
| | | | | | | decrease |
| Comparative | 76.4 | 3.2 | 89 | 3.7 | Fog | Fog/Print |
| Example 2 | | | | | | density |
| | | | | | | decrease |
| Comparative | 71.8 | 3.7 | 105 | 3.2 | Fog | Fog/Print |
| Example 3 | | | | | | density |
| | | | | | | decrease |
| Comparative | 76.3 | 3.4 | 98 | 4.6 | Fog | Fog/Print |
| Example 4 | | | | | | density |
| | | | | | | decrease |
| Comparative | 74.6 | 3.9 | 92 | 4.8 | Fog | Fog/Print |
| Example 5 | | | | | | density |
| | | | | | | decrease |
| Comparative | 93.2 | 0.15 | 25 | 2.6 | Favorable | Favorable |
| Example 6 | | | | | | |

Based on the above results in Table 4, it is understood that in Examples 1 to 12 in which a combination of a charge transport material, a resin binder, and a surface treatment inorganic oxide filler satisfying the above-described conditions of the Hansen solubility parameter was used for the charge transport layer, favorable abrasion resistance and electrical properties of the photoreceptor were achieved, and image quality was excellent at the initial stage and after printing of 10,000 sheets. Meanwhile, in Comparative Examples 1 to 6 in which the above-described conditions of the Hansen solubility parameter were not satisfied, the film wear loss after print durability test was large, or fog was generated on the image, and reduction of print density was also observed. It is also understood that abrasion resistance of the film was improved in the Examples as compared with the Comparative Examples in which no inorganic oxide was added for the improvement of film strength.

Based on the above, it was confirmed that a photoreceptor for electrophotography, by which it is possible to obtain a favorable image without image defects while inhibiting abrasion, can be provided by applying a charge transport material, a resin binder, and a surface-treated charge transport layer containing an inorganic oxide filler material satisfying conditions of the Hansen solubility parameters according to the present invention.

What is claimed is:

1. A photoreceptor for electrophotography, comprising:
a conductive substrate; and
a charge transport layer provided on the conductive substrate and containing a charge transport material, a resin binder, and an inorganic oxide filler surface-treated with a silane coupling agent,
wherein the charge transport material and the silane coupling agent have respective dipole-dipole force components that are a Hansen solubility parameter and a difference (ΔSPa) between the dipole-dipole force component of the charge transport material and the dipole-dipole force component of the silane coupling agent satisfies a relationship ΔSPa<1.0, and
wherein the resin binder and the silane coupling agent have respective London dispersion force components that are a Hansen solubility parameter and a difference (ΔSPb) between the London dispersion force component of the resin binder and the London dispersion force component of the silane coupling agent satisfies a relationship ΔSPb<2.5.

2. The photoreceptor for electrophotography according to claim 1, wherein the resin binder is a polycarbonate resin or a polyarylate resin.

3. The photoreceptor for electrophotography according to claim 1, wherein the inorganic oxide filler has a primary particle size of 1 to 200 nm.

4. The photoreceptor for electrophotography according to claim 1, wherein the charge transport material is a hole transport material.

5. The photoreceptor for electrophotography according to claim 1, wherein at least an undercoat layer, a charge generation layer, and the charge transport layer are provided in that order on the conductive substrate.

6. An electrophotography device, which has the photoreceptor for electrophotography according to claim 1.
